(19) United States
(12) Patent Application Publication
(10) Pub. No.: US 2008/0254806 A1
(43) Pub. Date: Oct. 16, 2008

(54) Method for Decentralized Assignment of Frequency Band to Base Stations

(76) Inventors: Michael Franzen, Bocholt (DE); Sebastian Obermanns, Bocholt (DE); Damian Wisniowski, Bocholt (DE)

Correspondence Address: STAAS & HALSEY LLP, SUITE 700, 1201 NEW YORK AVENUE, N.W., WASHINGTON, DC, 20005, US

(21) Appl. No.: 11/663,643

(22) PCT Filed: Jun. 28, 2005
(86) PCT No.: PCT/EP2005/053026

§ 371 Date: Mar. 24, 2008

(30) Foreign Application Priority Data
Sep. 23, 2004 (EP) 04022722.5

(51) Int. Cl. H04Q 7/20

(52) U.S. Cl. 455/450

(57) ABSTRACT

In a radio communication system having network-side and subscriber-side radio stations a frequency band is used for communication respectively by a subset of the network-side radio stations in time slots. The network-side radio stations are coordinated according to which network-side radio station(s) the frequency band can be used in a defined time slot. The network-side radio stations respectively emit a message containing a number having a value depending on the radio traffic range expected by the respective network-side radio station for the defined time slot.

### CROSS REFERENCE TO RELATED APPLICATIONS

This application is based on and hereby claims priority to European Application No. 04022722.5 filed on Sep. 23, 2004, the contents of which are hereby incorporated by reference.

### BACKGROUND OF THE INVENTION

A method is described for operating a radio communication system, in which a frequency band is used for communication. Further, a network-side radio station for carrying out the method is described.

In radio communication systems, messages containing voice information, image information, video information, SMS (Short Message Service), MMS (Multimedia Messaging Service) or other data for example are transmitted between the transmitting station and the receiving station via a radio interface using electromagnetic waves. Depending on the actual design of the radio communication system, the stations can be different types of subscriber-side radio stations or network-side radio stations such as base stations, repeater or radio access points. In a mobile radio communications system, at least part of the subscriber-side radio stations are mobile radio stations. The electromagnetic waves are emitted using carrier frequencies that are within the frequency band provided for the respective system.

Mobile radio communications systems are often designed as cellular systems e.g. according to the standard GSM (Global System for Mobile Communication) or UMTS (Universal Mobile Telecommunications System) with a network infrastructure including, e.g., base stations, devices for monitoring and controlling the base stations and other network-side devices. Apart from these cellular, hierarchical radio networks organized over a long range (supralocal), wireless local networks (WLANs, Wireless Local Area Networks) with a radio coverage area that is generally spatially much more limited also exist. The cells covered by the radio access points (AP: Access Point) of the WLANs are, with a diameter of for example a few hundred meters, small compared with customary mobile radio cells. Examples of different standards for WLANs are HiperLAN, DECT, IEEE 802.11, Bluetooth and WATM.

In radio communication systems, the radio stations' access to the shared transmission medium is regulated by multiple access methods/multiplex methods (Multiple Access, MA). With multiple access, the transmission medium can be divided between the radio stations in the time domain (Time Division Multiple Access, TDMA), in the frequency domain (Frequency Division Multiple Access, FDMA), in the code domain (Code Division Multiple Access, CDMA) or in the space domain (Space Division Multiple Access, SDMA). Combinations of multiple access methods are also possible, such as, for example, the combination of a frequency domain multiple access method with a code domain multiple access method.

The capacity of radio communication systems is limited by the interference. Once source of this interference is the common channel interference, i.e. interferences that are caused by sending signals on the same frequency band. In many systems, such as, for example, with GSM, there are several frequency bands available and neighboring base stations do not use the same frequency band at the same time. With UMTS, the frequency bands are not used for channel separation of neighboring cells, so that neighboring base stations communicate with subscriber-side radio stations on the same frequency band. Orthogonal radio channels are formed by differentiating the signals of different base stations in the code domain. Another possibility for generating orthogonal radio channels is separation in the time domain, i.e. the frequency band is available in time slots not to all base stations, but only to a subset of the base stations.

### SUMMARY OF THE INVENTION

An aspect is an efficient method for operating a radio communication system, in which a common frequency band is available to the network-side radio stations. A further aspect is a network-side radio station for carrying out the method.

In the method a frequency band is used for communication in a radio communication system having network-side and subscriber-side radio stations. In time slots, the frequency band is available to each subset of the network-side radio stations for communication purposes. The network-side radio stations are co-coordinated according to which network-side radio station(s) the frequency band can be used for in a defined time slot. Within the scope of the coordination, the network-side radio stations respectively emit a message containing a number, the value of which depends on the radio traffic range expected by the respective network-side radio station for the defined time slot.

In addition to the expected radio traffic range, the number can depend on other parameters, such as, for example, on a prioritization of the expected radio traffic range or the length of the period of time during which the frequency band was not available to the respective network-side radio station. In particular, the number can be a random number containing a probability density dependant on the radio traffic range expected by the respective network-side radio station for the defined time slot. A further possibility for generating the number is to use a function of the expected radio traffic range, which increases progressively along with rising expected radio traffic range, such as, for example, a linear dependence of the number of the expected radio traffic range.

In time slots the frequency band is not available to all network-side radio stations, but only to some of them. Here a time slot is a given period of time. The time slots, during which, as a result of the co-ordination between the network-side radio stations, the frequency can be used by the network-side radio stations, can, in principle, all be of the same length or differ from each other in respect of length. The method can be implemented with respect to all or to some of the time slots.

If the frequency band is available to a network-side radio station in a time slot, then the station can use the frequency band in the respective time slot to communicate with subscriber-side and/or with network-side radio stations, i.e. to receive messages from subscriber-side radio stations and/or to send messages to the stations, and/or to receive messages from network-side radio stations and/or to send messages to the stations. In addition to the frequency band, by way of which the network-side radio stations co-ordinate, one or several additional frequency bands can be used in the radio communication system, and the network-side radio stations may also co-ordinate on use of the frequency band(s).

Within the scope of the co-ordination process, the network-side radio stations communicate with each other, preferably without the involvement of a higher-ranking entity, such as, for example, a device for controlling the network-side radio stations. Thus there is an exchange of information between the network-side radio stations in order to co-ordinate the access to the frequency band in a decentralized or distributed manner. The method can be implemented in relation to the entirety of all network-side radio stations of a radio communication system, or in relation to a subset of this entirety, thus, for example, limited to the network-side radio stations of a given area.

The network-side radio stations, which co-ordinate by way of the radio resources, may belong to radio networks of one operator or different operators, they may use the same or different radio technologies.

In a further development, the co-ordination is carried out in such a way that the frequency band is not available to network-side radio stations that are not neighboring in the defined time slot. In the case of neighboring network-side radio stations, the radio cells are adjacent to each other. If the subset of the network-side radio stations that can use the frequency band at the same time, is, among other things characterized in that these network-side radio stations are not neighboring, then avoiding interferences increases the efficiency with which the frequency band is utilized.

It is of advantage if the frequency band is available to a network-side radio station in the defined time slot, when this the network-side radio station is sending a higher number than all its neighboring network-side radio stations. In this way the network-side radio station evaluates the numbers of all its neighboring network-side radio stations and can deduce from the comparison of these numbers with the number it sent whether the frequency band is available to it. In the case of an equally high number, other criteria can be brought in to decide which network-side radio station the frequency band can be used for.

In a further development, the co-ordination is carried out by a communication of the network-side radio stations on the frequency band, and/or on a different frequency band, and/or via landline. Different kinds of interfaces that are suitable for connecting network-side radio stations with each other can be used for this.

It is possible that a network-side radio station, which, based on the co-ordination, the frequency band can be used for in the defined time slot, communicates with at least one subscriber-side radio station and/or with at least one other network-side radio station on the frequency band during the defined time slot.

The network-side radio station has to co-ordinate with other network-side radio stations to determine which network-side radio station(s) the frequency band can be used for in a defined time slot, as well as to create and send a message as part of the co-ordination process containing a number, the value of the number depending on the radio traffic range expected by the network-side radio station for the defined time slot.

According to the method information is generated to be sent as part of the co-ordination process between network-side radio stations to determine which network-side radio station(s) the frequency band can be used for in a defined time slot, and messages are created containing a number, the value of which depends on the radio traffic range expected by the network-side radio station for the defined time slot, and information received as part of the co-ordination process is evaluated.

The method may be implemented using a computer program (with a technical effect extending beyond the normal physical interplay between program and processing unit) encoded on a recording medium, including a file bank, a configured processing unit, and a storage device or a server, on which files belonging to the computer program are stored.

### BRIEF DESCRIPTION OF THE DRAWINGS

These and other objects and advantages will become more apparent and more readily appreciated from the following description of an exemplary embodiment, taken in conjunction with the accompanying drawings of which:

FIG. 1 is a block diagram of a portion of a radio communication system, and

FIG. 2 is a time diagram indicating the sending of messages between base stations.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

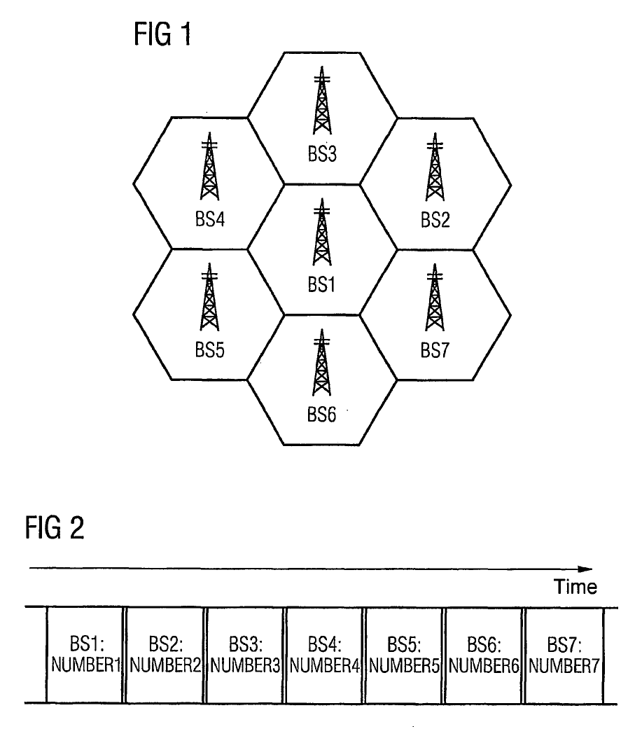

FIG. 1 shows a segment from a cellular radio communication system in the shape of a cluster of base stations, which includes the base station BS1 and its neighboring base stations BS2, BS3, BS4, BS5, BS6 and BS7. The radio communication system under consideration is a “single-frequency” radio communication system, i.e. a single frequency band is available to all base stations of the radio communication system. Time slots exist for communication with subscriber stations (not shown in FIG. 1). The frequency band is shared among the base stations in such a way that the frequency band can be used for one subset of the base stations at a time in each of the time slots. If the frequency band is available to a base station during a defined time slot, then the station can send messages to subscriber stations and/or receive messages from subscriber stations during this time slot.

The distribution of the frequency band among the base stations or the allocation of the frequency band to the base stations is not done with the involvement of a central device, but decentralized by co-ordination between the base stations. FIG. 2 shows an exchange of messages between the base stations BS1 to BS7 to co-ordinate by way of a time slot. First the base station BS1 sends a number NUMBER1, then the base station BS2 sends a number NUMBER2, then the base station BS3 sends a number NUMBER3, then the base station BS4 sends a number NUMBER4, then the base station BS5 sends a number NUMBER5, then the base station BS6 sends a number NUMBER6, and finally the base station BS7 sends a number NUMBER7. The numbers NUMBER1 to NUMBER7 are random numbers, which the base stations BS1 to BS7 generate beforehand. When the random numbers are generated, the traffic volume of each base station BS1 to BS7 expected on the frequency band is taken into consideration, i.e. the higher the expected traffic volume, the greater the probability of generating a high random number NUMBER1 to NUMBER7. Thus the probability density of the random numbers depends on the extent of the traffic volume. A base station, whose expected traffic volume is zero, generates a zero as the number to be sent, base stations with a higher load are more likely to generate high numbers. In addition, the base stations BS1 to BS7 know what message volume the subscriber stations in their respective radio cell would like to send and receive in the next time slot.

In addition to the described load dependency of the random numbers generated, additional parameters can also be involved in generating the numbers. The waiting time can influence how high the number is for instance: a base station to which the frequency band was not available during several time slots is more likely to generate a higher number.

The frequency band is available to those base stations BS1 to BS7 that send the highest numbers NUMBER1 to NUMBER7. For the purposes of co-ordination, after the numbers NUMBER1 to NUMBER7 have been sent, no further messages need be sent within the cluster considered, as each of the base stations BS1 to BS7 receives the number sent NUMBER1 to NUMBER7 of each other base station BS1 to BS7.

As a concrete example, the case is considered that the base station BS1 sends the number NUMBER1 with the value 40, the basis station BS2 sends the number NUMBER2 with the value 30, and the base station BS5 sends the number NUMBER5 with the value 10. The other base stations BS3, BS4, BS6 and BS7 send the number zero or do not send any number, as the number generated by them is equal to zero in each case. Therefore, in the time slot in question, the frequency band is thus available to the base station BS1, and not to the base stations BS2, BS3, BS4, BS5, BS6 and BS7.

While in FIG. 1 only one cluster including the base stations BS1 to BS7 is shown, a large number of overlapping clusters exist in the radio communication system. With regard to the numbering of the base stations within the cluster, the procedure is such that clusters are placed together in accordance with the cluster shown in FIG. 1, thus creating a pattern covering the area. With the exception of the base stations at the edge of the supply area of the radio communication system, all the base stations are part of a plurality of clusters, thus, for example, each base station is the central point of a cluster corresponding to the base station BS1 in FIG. 1. Clusters in the central point with base stations having the numbering BS1, and clusters in the central point with base stations having the numbering BS2 thus exist etc., whereby these clusters overlap each other. The sending of messages with the numbers NUMBER1 to NUMBER7 shown in FIG. 2 is done by all base stations of the radio communication system, whereby all base stations with the numbering BS1 send at the same time, all base stations with the numbering BS2 send at the same time, etc. Each base station receives the numbers sent by their neighboring base stations and evaluates these numbers. Signals sent from further away, i.e. not from neighboring base stations are not taken into consideration. A base station regards the frequency band as being available for it for the next time slot, if all the base stations neighboring it send a lower number than it does itself.

If neighboring base stations send the same number, then an additional criterion can be brought in to decide on the assignment of the frequency band between these base stations, such as, for example, which of the base stations sent the number first or which of the base stations carries the higher number. To increase the equality of opportunity, the transmitter sequence and/or the numbering of the base stations can be varied with time.

The method described ensures that in no case is the frequency band available to two neighboring base stations at the same time. This avoids strong interferences, and hence the frequency band is utilized effectively. Too big a repeat distance, i.e. too big a distance between two base stations, which can use the frequency band at the same time, is however disadvantageous in relation to the utilization of the radio,resource. A large repeat distance arises, for example, when a series of neighboring base stations send monotonic decreasing numbers. In this case the frequency band is available to the first base station in the series, but not to all the other base stations in the series. To get round this, it is possible for a base station not to send the number it generated but to send a zero, if it determines that a base station neighboring it has sent a number, which is higher than the number it generated. This procedure, however, causes an unequal distribution with respect to the base stations, which “win” in the co-ordination process, depending on the sequence of sending during co-ordination. To get round this, the send sequence can be rotated during the co-ordination process.

As shown in FIG. 2, the period of time for the co-ordination process is divided up into a number of sub sections, whereby during each subsection exactly one base station in a cluster sends, while the other base stations in the cluster receive. The number of subsections, which can, as the case may be, be separated by short breaks to compensate for run-time errors and errors in the frame synchronization, corresponds to the number of base stations in a cluster, i.e. the number of base stations neighboring each base station plus one. The information sent during the co-ordination process must robustly encoded, so that the reception of the signal from a neighboring base station is largely error-free despite signals with the same numbering being emitted from base stations further away.

Instead of the previously described random numbers, it is also possible for a function without random character to be used to generate the numbers used in the co-ordination process, so that for each base station, the number generated for a given radio traffic volume is the same and increases along with the level of radio traffic volume. This is however disadvantageous for instance in that the frequency band is never or very seldom available to a base station with an average radio traffic volume, which neighbors a base station with high radio traffic volume.

The exchange of signaling messages between the base stations BS1 to BS7 shown in FIG. 2 can take place on the frequency band, by way of which allocation the base stations BS1 to BS7 co-ordinate. In this case it is expedient if, after the period of time for the co-ordination messages shown in FIG. 2, there follows the time slot that was co-coordinated in the period of time shown in FIG. 2. After the time slot there follows again a period of time for the co-ordination, followed by a time slot, etc. A co-ordination is thus carried out by the base stations BS1 to BS7 in a time slot of the coordination process in each instance by way of the following time slot. The time slots, which can be used to communicate with the subscriber stations, are thus interrupted by periods of time, which are used for co-ordination between the base stations. Hereby, it is also possible that the base stations do not co-ordinate on the next, but on the next but one or a further off time slot.

Alternatively a different frequency band, in particular a narrower frequency band can also be used for the co-ordination, so that the broad frequency band is not “wasted” for the co-ordination between the base stations. In this case the co-ordination can occur parallel to the position of a time slot. Advantageously during a time slot, the co-ordination regarding the next time slot occurs, but co-ordination can also be carried out regarding the next but one or a further off time slot. The other frequency band can be in a frequency domain, which necessitates the use of a different radio technology, such as, for example, radio link system for radio frequencies in the infrared range.

Further, it is also possible that the co-ordination between the base stations is carried out not by radio but via line. In this case, as also when a different frequency band is used for the co-ordination, the time slots for the communication with the subscriber stations on the frequency band can follow each other directly, without interruption for the co-ordination time period.

So far the case was considered that the base stations use the frequency band if it is available to them for communication purposes, for communicating with subscriber stations that are in their respective radio cell. In addition or alternatively, it is possible that a base station uses the frequency band available to it by communicating with one or several other base stations. This is of particular advantage for base stations in the form of network-side relay stations, which, in contrast to the customary base stations are not linked to the infrastructure network of the radio communication system, but which forward the messages they receive to other relay stations or base stations.

The radio communication system described, in which the frequency band is not always available to each individual cell, but only at times determined by co-ordination between the base stations, is particularly suitable for burst type radio traffic, as, for example, for Web Browsing and Interactive Gaming. This comes from the fact that these spontaneous data transmissions in neighboring radio cells frequently do not occur at the same time. The co-ordination between the base stations allows for unequal load distributions in the radio cells, as the frequency band is more often available to a base station, in whose cell a high radio traffic volume predominates, than to a base station, in whose cell there is only a low radio traffic volume.

While a cluster size of 7 was considered in the concrete example, the clusters used can be of any size. A cluster may also include base stations that are not neighboring.

The described method is advantageous in that the signaling outlay incurring during the co-ordination process is not dependent on the number and the radio traffic volume of the subscriber stations. The reason for this is that only the base stations participate in the co-ordination process and their number is fixed and each has a preset period of time available to it for sending the information required for the co-ordination process.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method for operating a radio communication system having network-side and subscriber-side radio stations and using a frequency band for communication to a subset of the network-side radio stations in time slots, comprising:
sending messages by the network-side radio stations, respectively, containing a number having a value which depends on a radio traffic range expected by at least one network-side radio station for a defined time slot; and
coordinating the network-side radio stations with one another based on the messages, to determine to which of the network-side radio stations the frequency band is available in the defined time slot.

10. The method as claimed in claim 9, wherein said coordinating makes the frequency band available to at least one non-neighboring network-side radio station in the defined time slot.

11. The method as claimed in claim 10, wherein the number is a random number with a probability density dependent on the radio traffic range expected by a respective network-side radio station for the defined time slot.

12. The method as claimed in claim 11, wherein the frequency band is available to one of the network-side radio stations in the defined time slot, if the one of the network-side radio stations emits a higher number than all neighboring network-side radio stations.

13. The method as claimed in claim 12, wherein said sending of the messages is between the network-side radio stations on at least one of the frequency band, a different frequency band, and via a land line.

14. The method as claimed in claim 13, further comprising the one of the network-side radio stations, to which the frequency band is available in the defined time slot, communicating with at least one subscriber-side radio station and/or with at least one other network-side radio station on the frequency band during the defined time slot.

15. A network-side radio station in a radio communication system having other network-side radio stations and subscriber-side radio stations, where a frequency band used for communication in the radio communication system is available for communication with a subset of the network-side radio stations in time slots, respectively, comprising:
means for creating and sending a message containing a number having value depending on a radio traffic range expected by said network-side radio station for the defined time slot; and
means for coordinating with at least some of the other network-side radio stations to determine a selected network-side radio station for which the frequency band is available in a defined time slot.

16. A computer-readable medium encoded with a program that when executed by a processor controls a network-side radio station in a radio communication system having other network-side radio stations and subscriber-side radio stations, where a frequency band used for communication in the radio communication system is available for communication with a subset of the network-side radio stations in time slots, respectively, to perform a method comprising:
sending messages by the network-side radio stations, respectively, containing a number having a value which depends on a radio traffic range expected by at least one network-side radio station for a defined time slot; and
coordinating the network-side radio stations with one another based on the messages, to determine to which of the network-side radio stations the frequency band is available in the defined time slot.
